(19) United States
(12) Patent Application Publication
(10) Pub. No.: US 2026/0237084 A1
(43) Pub. Date: Aug. 13, 2026

(54) INFORMATION PROCESSING DEVICE AND INFORMATION PROCESSING METHOD

(71) Applicant: Sony Semiconductor Solutions Corporation, Kanagawa (JP)

(72) Inventor: Nicolas VAN DER NOOT, Basingstoke (GB)

(73) Assignee: Sony Semiconductor Solutions Corporation, Kanagawa (JP)

(21) Appl. No.: 19/153,338

(22) PCT Filed: Feb. 22, 2024
(86) PCT No.: PCT/EP2024/054537

§ 371 Date: Aug. 4, 2025

(30) Foreign Application Priority Data
Feb. 24, 2023 (EP) 23158489.7

(51) Int. Cl. G06T 7/33; G06T 7/50; G06T 7/73; G06T 17/00; G06V 10/26; G06V 10/34; G06V 10/762; G06V 10/764; G06V 10/82; G06V 20/70; G06V 40/10

(52) U.S. Cl. CPC G06T 7/344; G06T 7/50; G06T 7/75; G06T 17/00; G06V 10/26; G06V 10/34; G06V 10/762; G06V 10/764; G06V 10/82; G06V 20/70; G06V 40/10; G06T 2200/04; G06T 2207/20084; G06T 2207/30196

(57) ABSTRACT

An information processing device for transforming depth sensor data into 3D skeleton data representing a fitted 3D skeleton model of a body in a scene, comprising circuitry configured to: obtain segmented scene data including a plurality of data points, wherein each data point includes a 3D position, a class label indicating one of a plurality of classes, each class representing a body part, and a class belonging score indicating a likeliness that the data point belongs to the class indicated by the class label; and fit the 3D skeleton model to the segmented scene data to obtain the 3D skeleton data.

### TECHNICAL FIELD

The present disclosure generally pertains to an information processing device and an information processing method.

### TECHNICAL BACKGROUND

Getting the 3D skeleton of a human, e.g., in a cabin inside the car may be useful for in-cabin monitoring systems to provide driver assistance functionality or the like, other safety-related applications, surveillance applications, medical applications or non-safety related applications (e.g., gaming, touchless interaction, gymnastic coach, etc.).

The most common approach to compute a 3D skeleton consists in training a neural network (NN) capable of directly outputting 2D or 3D positions of joints—typically using heat maps—to mimic ground truth 2D/3D positions. In other words, the NN oversees the full pipeline from input images to joints 2D/3D positions.

This approach may be easy to implement and may require easier ground truth, however, it may, in some cases, have limited accuracy, since the NN must perform the full processing pipeline (understanding images, understanding what 3D is . . . ) without help. It may further be difficult to make small adjustments without running a full new training procedure (potentially requiring more tagged data).

Moreover, such approaches may, in some cases, have difficulties in dealing with occlusion, work better in 2D and have deteriorated results when the inferred 2D joint position is close to the environment. The 3D is usually obtained using multiple camera point of views or depth maps. However, going from 2D to 3D may be more difficult than performing all the computations in 3D space. Furthermore, these approaches may not be able, in some cases, to take 3D constraints (body ratios, limb symmetries . . . ) into account.

Although there exist techniques for computing a 3D skeleton from images, it is generally desirable to improve the existing techniques.

### SUMMARY

According to a first aspect, the disclosure provides an information processing device for transforming depth sensor data into 3D skeleton data representing a fitted 3D skeleton model of a body in a scene, comprising circuitry configured to:
obtain segmented scene data including a plurality of data points, wherein each data point includes a 3D position, a class label indicating one of a plurality of classes, each class representing a body part, and a class belonging score indicating a likeliness that the data point belongs to the class indicated by the class label; and
fit the 3D skeleton model to the segmented scene data to obtain the 3D skeleton data.

According to a second aspect, the disclosure provides an information processing method for transforming depth sensor data into 3D skeleton data representing a fitted 3D skeleton model of a body in a scene, comprising:
obtaining segmented scene data including a plurality of data points, wherein each data point includes a 3D position, a class label indicating one of a plurality of classes, each class representing a body part, and a class belonging score indicating a likeliness that the data point belongs to the class indicated by the class label; and
fitting the 3D skeleton model to the segmented scene data to obtain the 3D skeleton data.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates an embodiment of an in-cabin monitoring system in a vehicle;

FIG. 2 schematically illustrates in a flow diagram an embodiment of an information processing method;

FIG. 3 schematically illustrates an embodiment of a 3D skeleton model;

FIG. 4 schematically illustrates an enlarged portion of the embodiment of the 3D skeleton model of FIG. 3; and

FIG. 5 schematically illustrates in a flow diagram an embodiment of an information processing method.

### DETAILED DESCRIPTION OF EMBODIMENTS

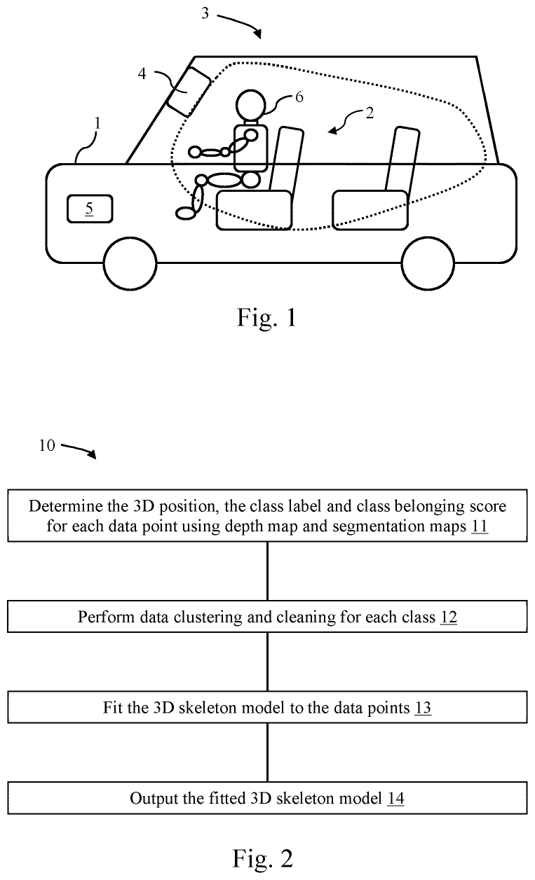

Before a detailed description of the embodiments under reference of FIG. 1 is given, general explanations are made.

As mentioned in the outset, getting the 3D skeleton of a human, e.g., in a cabin inside the car may be useful for in-cabin monitoring systems to provide driver assistance functionality or the like. This may further be useful for other safety-related applications, surveillance applications, medical applications or non-safety related applications (e.g., gaming, touchless interaction, gymnastic coach, etc.).

The most common approach to compute a 3D skeleton consists in training a neural network (NN) capable of directly outputting 2D or 3D positions of joints—typically using heat maps—to mimic ground truth 2D/3D positions. In other words, the NN oversees the full pipeline from input images to joints 2D/3D positions.

This approach may be easy to implement and may require easier ground truth, however, it may, in some cases, have limited accuracy, since the NN must perform the full processing pipeline (understanding images, understanding what 3D is . . . ) without help. It may further be difficult to make small adjustments without running a full new training procedure (potentially requiring more tagged data).

As further mentioned in the outset, moreover, such approaches may, in some cases, have difficulties in dealing with occlusion, work better in 2D and have deteriorated results when the inferred 2D joint position is close to the environment. The 3D is usually obtained using multiple camera point of views or depth maps. However, going from 2D to 3D may be more difficult than performing all the computations in 3D space. Furthermore, these approaches may not be able, in some cases, to take 3D constraints (body ratios, limb symmetries . . . ) into account.

It has been recognized that a lack of segmentation in such approaches may prevent using this information to improve accuracy and that, additionally, a computation time may be of particular importance which may be comparable long for an NN covering the full pipeline.

Hence, it has thus been recognized that a method for getting a 3D skeleton should be accurate while having a comparable short computation time.

Thus, it has been recognized that a segmented 3D point cloud should be used as input for an optimization routine to get the 3D skeleton. In other words, the input should be a cloud of 3D points where each point has the following information: (i) 3D position, (ii) class label, where each class is a body part and (iii) a score representing its likeliness to belong to this class. This data is input into an optimization routine capable of generating an accurate 3D skeleton with a relatively low computation time.

Hence, some embodiments pertain to an information processing device for transforming depth sensor data into 3D skeleton data representing a fitted 3D skeleton model of a body in a scene, including circuitry configured to:
obtain segmented scene data including a plurality of data points, wherein each data point includes a 3D position, a class label indicating one of a plurality of classes, each class representing a body part, and a class belonging score indicating a likeliness that the data point belongs to the class indicated by the class label; and
fit the 3D skeleton model to the segmented scene data to obtain the 3D skeleton data.

The information processing device may be a processing module, a computer such as a board-computer in a vehicle, a server, a mobile device such as a smartphone, or the like.

The information processing device may be used for various applications in many different environments, for example, for in-cabin monitoring in a vehicle (e.g., driver monitoring), other safety-related applications, surveillance applications, medical applications or non-safety related applications (e.g., gaming, touchless interaction, gymnastic coach, etc.) which require the determination of a size, position and posture of a body.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus. The data bus may be or may be based on a Controller Area Network (CAN) bus, an I²C (Inter-Integrated Circuit) interface, or the like.

Generally, a depth sensor acquires depth sensor data of a scene which may represent a depth map of the scene, for example, the depth sensor may be a time-of-flight sensor, a structured light camera, a stereo camera or the like. Such sensors typically include an image sensor having a plurality of image pixels arranged in rows and columns for detecting light based on which a depth value is acquired (such that a depth value is acquired for each pixel). The depth value may be transformed into a 3D (three-dimensional) coordinate system in which positions of objects in the scene are described. Hence, the depth sensor data include a plurality of data points, each data point includes a depth value.

In some embodiments, the depth sensor data is fed into a segmentation neural network, which are generally known, trained to output the class label and the class belonging score of each data point.

Generally, it is not compulsory to use a segmentation algorithm such as a segmentation neural network. The term “segmented” only means that a set of data points with 3D positions has a class label (with likeliness that the data point belongs to the class indicated by the class label). A similar input may be obtained using heat maps.

In some embodiments, the circuitry is configured to obtain the segmented scene data by obtaining and inputting the depth sensor data into a segmentation neural network to obtain the class label and the class belonging score for each data point, and determining the 3D position of each data point based on the depth sensor data.

The segmentation of the depth sensor data may be further improved by obtaining additionally a red-green-blue (“RGB”) or infrared (“IR”) image of the (same) scene. In some embodiments, the RGB or IR image is obtained from an RGB or IR image sensor. In some embodiments, the depth sensor is an indirect time-of-flight sensor and the RBG or IR image is obtained from the amplitude image and the depth map is obtained from the phase image.

In other embodiments, the segmented scene data may be obtained from a neural network which is trained on heat maps providing similar input and by using the depth values at the heat map's pixel locations.

As mentioned above, the segmented scene data include a plurality of data points (the number of data points may be N, wherein N is an Integer), and the plurality of data points may be denoted as:

$$X = \{ x 1 , x 2 , … , xN \} = \{ ( \vec{{p}_{1}} , {class}_{1} , {k}_{1} ) , ( \vec{{p}_{2}} , {class}_{2} , {k}_{2} ) , … , ( \vec{{p}_{N}} , {class}_{N} , {k}_{N} ) \} . \qquad ( 1 )$$

Each data point xi includes a 3D position \vec{pᵢ}, a class label classᵢ and a class belonging score kⱼ.

The plurality of classes (the number of classes may be M, wherein M is an Integer) may be denoted as:

$$C = \{ {c}_{1} , {c}_{2} , … , {c}_{M} \} . \qquad ( 2 )$$

The class label classᵢ is one of a plurality of classes, i.e., classᵢ is one of {c₁, c₂, . . . , c_{M}}.

The plurality of data points thus typically includes one or more sets of data points ({X1, X2, . . . , XK}, wherein K is an Integer and is smaller or equal to M), each set including data points belonging to the same class (i.e., with the same class label).

Each class represents a body part of a body, e.g., the plurality of classes may represent head, neck, shoulder (left and right), upper arm (left and right), elbow (left and right), lower arm (left and right), hand (left and right), chest, pelvis part (left and right), middle of pelvis (middle between pelvis parts), upper leg (left and right), knee (left and right), lower leg (left and right) and foot (left and right)—without limiting the disclosure in this regard. Other divisions of the body into body parts (and thus classes) may be appropriate as well.

Generally, the body may be any body or a part of a body having a skeleton structure such as a human or an animal or part of the human or the animal or a robot or part of the robot.

The 3D skeleton model includes a plurality of skeleton model parameters which represent parts of the body and at least their relative position to each other.

Generally, the 3D skeleton model may be fitted using any known optimization method, e.g., Newton's optimization, Quasi-Newton, Gauss-Newton, Levenberg-Marquardt, gradient descent method or the like.

The fitting is based on optimizing (in some embodiments minimizing) an energy function (which may also be referred to as error function) representing a skeleton energy representing a deviation between the skeleton model parameters and the plurality of data points.

The 3D skeleton data include the optimized skeleton model parameters of the 3D skeleton model.

In some embodiments, the 3D skeleton model has a graph structure including a plurality of interconnected anchor points including a plurality of joints, wherein each anchor point belongs to one of the plurality of classes.

In such embodiments, the anchor points correspond to the vertices of the graph and each connection between the anchor points corresponds to an edge of the graph.

In this way, in such embodiments, the body is described, e.g., by having anchor points for body parts which represent a joint such as, for example, (left and right) shoulder, (left and right) elbow, (left and right) pelvis part, (left and right) knee, (left and right) foot, (left and right) hand, and having other anchor points for certain other body parts such as, for example, head, neck, chest and middle of pelvis. In such embodiments, the connections between the anchor points describe, for example, certain bones or the spine or the like.

In some embodiments, the plurality of anchor points includes one anchor point for each different class of a subset of the plurality of classes, and thus the plurality of anchor points may be denoted as (the number of anchor points may be L, wherein L is an Integer and equal to or smaller than M):

$$A = \{ A 1 , A 2 , … , AL \} = \{ ( \vec{{q}_{1}} , {c}_{1} ) , ( \vec{{q}_{2}} , {c}_{2} ) , … , ( \vec{{q}_{L}} , {c}_{L} ) \} . \qquad ( 3 )$$

In particular, in some embodiments, the plurality of anchor points includes one anchor point for each different class of the plurality of classes, and thus the plurality of anchor points may be denoted as:

$$A = \{ A 1 , A 2 , … , AM \} = \{ ( \vec{{q}_{1}} , {c}_{1} ) , ( \vec{{q}_{2}} , {c}_{2} ) , … , ( \vec{{q}_{M}} , {c}_{M} ) \} . \qquad ( 4 )$$

Each anchor point AJ includes a 3D position q; and a class label c; corresponding to the class representing the body part with which the anchor point is associated.

The length and angle of the connection between two anchor points is directly determinable from the 3D positions of the plurality of anchor points. For example, spherical coordinates may be used having an origin at the 3D position of one anchor point such that the spherical coordinates indicate the 3D position of the other anchor point relative to the one in which the local coordinate system is centered.

In some embodiments, the 3D skeleton model is fitted by updating the 3D positions of the plurality of anchor points such that a skeleton energy is minimized.

In some embodiments, the 3D skeleton model is fitted under at least one of the following constraints: symmetric limb lengths, predetermined body ratios and predetermined connection angle ranges.

Generally, the 3D skeleton model may be fitted without any constraints in some embodiments, however, this may result in lower accuracy.

As mentioned above, the length and angle of connection between two anchor points is directly determinable from the anchor points' 3D positions. The constraints may be enforced by managing and, if needed, restricting the possible values of the lengths and angles of the connections.

Gimbal lock issues may thus be resolved by checking the current connection angles and enforcing range compliance when close to instable operation. Moreover, the frame reference may be changed when close to instable operation.

The predetermined body ratios may be obtained from scientific literature or the like, as well as the predetermined connection angle ranges (e.g., some joint angles may be restricted by a maximum and minimum angle). The predetermined body ratios may be used to compute the limb lengths relative to each other.

In some embodiments, further constraints may be applied such as predetermined limb lengths and/or predetermined connection lengths between the anchor points.

In some embodiments, the limb lengths are learned by running (in parallel) the same skeleton energy minimization algorithm, but without constraints on the 3D skeleton structure (e.g., each 3D joint may freely move). These lengths may be refined over time (additional constraints may be used like the aforementioned body symmetry and realistic body ratios).

In some embodiments, the skeleton energy is based on a plurality of spring energy formulas (based on “virtual springs” attached between the segmented 3D points and the corresponding 3D anchor points), wherein in each spring energy formula stiffness is the class belonging score and displacement is the distance between the 3D position of the anchor point and the 3D positions of the corresponding data points.

In such embodiments, the skeleton energy U^{j}, for each set of data points XJ with class label cⱼ having an associated anchor point AJ, is given by:

$${U}^{j} = {\sum }_{f = 1}^{F} \frac{1}{2} \cdot {k}_{f} \cdot {\vert \vec{{p}_{f}^{j}} - \vec{{q}_{j}} \vert}^{2} , \qquad ( 5 )$$

wherein F is the number of data points in XJ with class label cⱼ,

$$\vec{{p}_{f}^{j}}$$

is the 3D position of data point f in the set of data points XJ with class label cⱼ, k_{f} is the class belonging score of data point f and \vec{qⱼ} is the 3D position of the anchor point with class label cⱼ.

In some embodiments, other contributions may be added to the skeleton energy such as tracking, hardcoded length, attractors, orientation references or the like.

It has been recognized that in some classes the data points may scatter in position due to noise or occlusions such that a position of an anchor point fitted to such data points may have a lower accuracy.

Thus, it has been recognized that the data points of each class should be clustered and cleaned before fitting the 3D skeleton model to them.

Hence, in some embodiments, the circuitry is configured to generate clusters for each set of data points belonging to the same class before fitting the 3D skeleton model.

Generally, data clustering methods are known, and any known method may be used, e.g., leader-follower clustering.

It has been recognized that in order to clean up the data points in each class, the clusters should be ranked indicating a quality or trust level of the cluster.

Hence, in some embodiments, the circuitry is configured to assign a cluster score to each cluster.

In some embodiments, the circuitry is configured to keep for each class only the cluster with the highest cluster score.

Additionally, in some embodiments, the circuitry is configured to remove all the data points of a class when the highest cluster score did not reach a predefined threshold.

In some embodiments, the cluster score is the sum of the class belonging scores of the data points included in the respective cluster.

The cluster score may be tuned with some extra contributions like tracking and neighbor relations (e.g., distance between neighbors, depth profile on the line joining two neighbors, . . . ).

Some embodiments pertain to an (corresponding) information processing method for transforming depth sensor data into 3D skeleton data representing a fitted 3D skeleton model of a body in a scene, including:
obtaining segmented scene data including a plurality of data points, wherein each data point includes a 3D position, a class label indicating one of a plurality of classes, each class representing a body part, and a class belonging score indicating a likeliness that the data point belongs to the class indicated by the class label; and
fitting the 3D skeleton model to the segmented scene data to obtain the 3D skeleton data.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically illustrated an embodiment of an in-cabin monitoring system 3 in a vehicle 1 having a cabin 2, which is discussed in the following.

The in-cabin monitoring system 3 includes a depth sensor 4 (field-of-view of the depth sensor 4 is illustrated by the dotted line) and an information processing device 5 and, generally, performs monitoring of the driver 6, e.g., posture recognition of the driver 6 for providing safety features.

The depth sensor 4 may be time-of-flight sensor, a structured light camera, a stereo camera or the like which is configured to acquire depth sensor data of the cabin 2.

The information processing device 5 is a board-computer and includes circuitry (not shown) such as a processor, data storage and data bus to perform various functions as described herein.

The information processing device 5 obtains the depth sensor data from the depth sensor 4, e.g., via a CAN (“Controller Area Network”).

FIG. 2 schematically illustrates in a flow diagram an embodiment of an information processing method 10, which is discussed in the following under reference of FIGS. 1, 2, 3 and 4.

The information processing method 10 is performed by the information processing device 5 (abbreviated as IPD 5 in the following) of FIG. 1.

As mentioned above, the IPD 5 obtains depth sensor data from the depth sensor 4, wherein the depth sensor data include a plurality of data points, each having a depth value (thereby representing a depth map of the cabin 2).

At 11, the IPD 5 inputs the obtained depth sensor data into a segmentation neural network to obtain the class label and the class belonging score for each data point.

As mentioned above, input of the depth sensor data into a segmentation neural network is not compulsory. In other embodiments, the depth sensor data is input first into a neural network which outputs a heat map which is then input to a segmentation neural network.

The class label indicates one of a plurality of classes, each class representing a body part of the driver 6.

The class belonging score indicates a likeliness that the data point belongs to the class indicated by the class label. In other words, a probability that the data point belongs to a certain body part of the driver 6 indicated by the class label.

Basically, the segmentation neural network outputs one segmentation map per body part, each segmentation map including a set of data points which belong to the same class, and which have assigned a probability that the data point belongs to the class.

Moreover, at 11, the IPD 5 determines the 3D position of each data point based on the depth sensor data using their depth value.

Hence, at the end of 11, the IPD 5 has obtained segmented scene data of the cabin 2, which are denoted as:

$$X = \{ x 1 , x 2 , … , xN \} = \{ ( \vec{{p}_{1}} , {class}_{1} , {k}_{1} ) , ( \vec{{p}_{2}} , {class}_{2} , {k}_{2} ) , … , ( \vec{{p}_{N}} , {class}_{N} , {k}_{N} ) \} . \qquad ( 6 )$$

Here, N is the number of data points, and each data point xi includes the determined 3D position \vec{pᵢ}, the class label class; and the class belonging score kᵢ.

The plurality of classes (the number of classes may be M, wherein Mis an Integer) may be denoted as:

$$C = \{ {c}_{1} , {c}_{2} , … , {c}_{M} \} . \qquad ( 7 )$$

The class label classᵢ is one of a plurality of classes, i.e., class; is one of {c₁, c₂, . . . , c_{M}}.

The sets of data points for each detected class may be denoted as:

$$\{ X 1 , X 2 , … , XK \} , \qquad ( 8 )$$

wherein K is an Integer and is smaller or equal to M depending, e.g., on the field-of-view of the depth sensor 4 or occlusions.

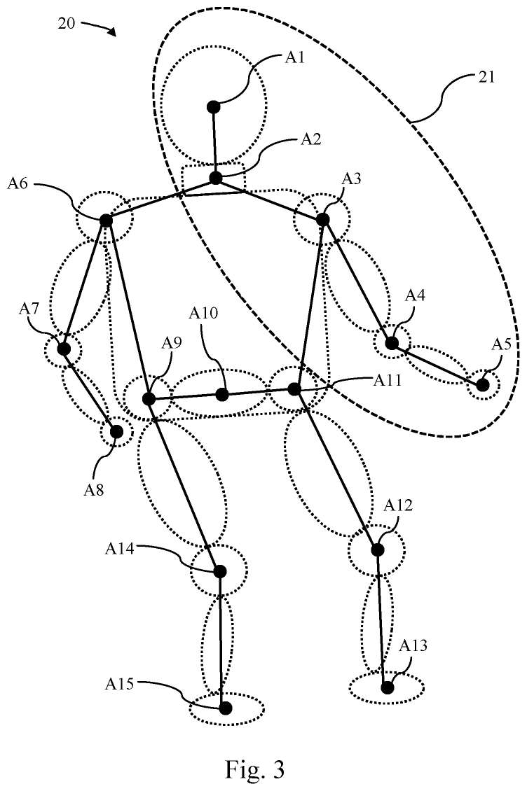

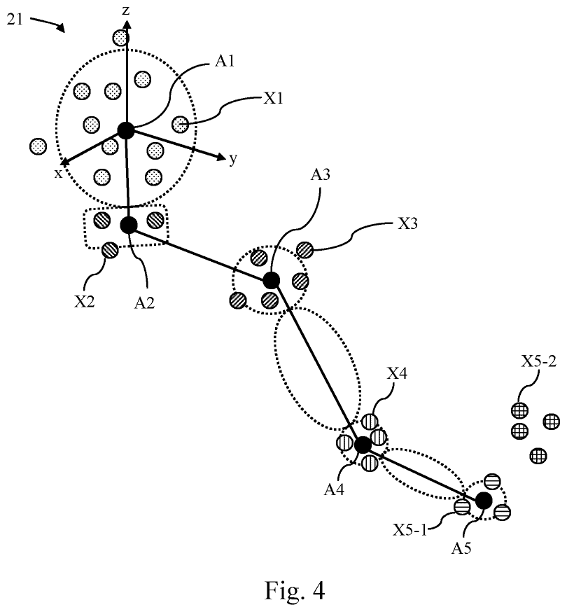

At 12 and 13, the IPD 5 performs data clustering and cleaning for each class and fits a 3D skeleton model to the data points, as will be discussed in the following under reference of FIGS. 3 and 4.

FIG. 3 schematically illustrates an embodiment of a 3D skeleton model 20, which is discussed in the following.

The 3D skeleton model 20 is a 3D skeleton model of a human body.

As mentioned above, this is an embodiment related to humans, however, other applications for animals or non-living objects, e.g., a robot are envisaged as well.

In order to construct the 3D skeleton model 20, the body is divided into a plurality of body parts, wherein each body part in FIG. 3 is illustrated by a dotted form.

Here, without limiting the disclosure in this regard, the body is divided into head, neck, chest, left and right shoulder, left and right upper arm, left and right elbow, left and right lower arm, left and right hand, left and right pelvis part, middle of pelvis, left and right upper leg, left and right knee, left and right lower leg, and left and right foot (twenty-four body parts).

Hence, each of the plurality of classes represents one of the aforementioned body parts (thus M=24).

The 3D skeleton model 20 has a graph structure including a plurality of anchor points A1-A15 including a plurality of joints (A3, A4, A5, A6, A7, A8, A9, A11, A12, A13, A14, A15), wherein each anchor point A1-A15 belongs to one of the plurality of classes.

The plurality of anchor points (the number of anchor points may be L, wherein L is an Integer and equal to or smaller than M—in this embodiment it is smaller) may be denoted as:

$$A = \{ A 1 , A 2 , … , AL \} = \{ ( \vec{{q}_{1}} , {c}_{1} ) , ( \vec{{q}_{2}} , {c}_{2} ) , … , ( \vec{{q}_{L}} , {c}_{L} ) \} . \qquad ( 9 )$$

Each anchor point AJ includes a 3D position \vec{qⱼ} and a class label cⱼ corresponding to the class representing the body part with which the anchor point is associated.

The connections between the anchor points describe, for example, certain bones.

In order to discuss the data clustering, cleaning and fitting, an enlarged portion 21 of the 3D skeleton model 20 is shown in FIG. 4 together with exemplarily sets of data points (X1, X2, X3, X4, X5-1 and X5-2).

FIG. 4 schematically illustrates an enlarged portion 21 of the embodiment of the 3D skeleton model 20 of FIG. 3, which is discussed in the following.

The first set of data points X1 includes the data points illustrated by the dotted dots which are classified as belonging to the head indicated by a first class label value which is the same as for anchor point A1.

The second set of data points X2 includes the data points illustrated by the left to right striped dots which are classified as belonging to the neck indicated by a second class label value which is the same as for anchor point A2.

The third set of data points X3 includes the data points illustrated by the right to left striped dots which are classified as belonging to the left shoulder indicated by a third class label value which is the same as for anchor point A3.

The fourth set of data points X4 includes the data points illustrated by the up and down striped dots which are classified as belonging to the left elbow indicated by a fourth class label value which is the same as for anchor point A4.

A fifth set of data points X5 (no reference sign) includes a first subset X5-1 and a second subset X5-2 which are classified as belonging to the left hand indicated by a fifth class label value which is the same as for anchor point A5.

To enhance accuracy of the fit of the 3D skeleton model 20 to the data points, the IPD 5 generates, at 12, data clusters for each set of data points X1-X5—each including data points belonging to the same class—e.g., using leader-follower clustering, which is generally known.

For illustration only, the data clusters for each set of data points X1-X4 corresponds to the set of data points X1-X4, respectively.

However, for the fifth set of data points X5, the IPD 5 generates two clusters corresponding to the first subset X5-1 and the second subset X5-2.

In order to enhance accuracy of the fit, the IPD 5 assigns a cluster score to each cluster corresponding to the first subset X5-1 and the second subset X5-2.

Here, the IPD 5 determines the cluster score as the sum of the class belonging scores of the data points included in the respective cluster.

Hence, for the first subset X5-1, the cluster score is given by:

$$cluster\_score \_ 1 = {\sum }_{g = 1}^{G} {k}_{g} , \qquad ( 10 )$$

wherein G is the number of data points in X5-1 and k_{g} is the class belonging score of data point g in X5-1.

Hence, for the first subset X5-2, the cluster score is given by:

$$cluster\_score \_ 2 = {\sum }_{h = 1}^{H} {k}_{h} , \qquad ( 11 )$$

wherein H is the number of data points in X5-2 and kₕ is the class belonging score of data point h in X5-2.

For the sake of illustration, it is assumed that cluster_score_1>cluster_score_2.

Hence, the IPD 5 keeps only the first subset X5-1, since it has the highest cluster score.

Once the data points are clustered and cleaned in each class, the IPD 5 fits, at 13, the 3D skeleton model 20 to the data points.

This will be discussed in the following.

In this embodiment, the IPD 5 fits the 3D skeleton model 20 to the data points by using Newton's iterative optimization method.

At first, each 3D position of the anchor points A1-A15 is initialized with a predetermined value (which may represent typical values for the driver 6).

Then, the IPD 5 starts the iterative optimization.

The IPD 5 constructs for each anchor point A1-A15 a local spherical coordinate system (x, y, z) having its origin at the initialized value of A1-A15, respectively.

Then, the IPD 5 determines a skeleton energy of the full 3D skeleton model 20, which is given by:

$$U = {\sum }_{j = 1}^{L} {U}^{j} = {\sum }_{j = 1}^{L} {\sum }_{fj = 1}^{Fj} \frac{1}{2} \cdot {k}_{fj} \cdot {\vert \vec{{p}_{fj}^{j}} - \vec{{q}_{J}} \vert}^{2} , \qquad ( 12 )$$

wherein Fj is the number of data points in XJ,

$$\vec{{p}_{fj}^{j}}$$

is the 3D position of data point fj in XJ, k_{fj} is the class belonging score of data point fj and q; is the 3D position of the anchor point AJ.

If there are no data points XJ for anchor point AJ with the same class label, the anchor point AJ does not contribute to the skeleton energy but may be adapted according to the fitting constraints (e.g., symmetric limb lengths, predetermined body ratios and predetermined connection angle ranges).

The IPD 5 optimizes the 3D position \vec{qⱼ} of each anchor point AJ such that the skeleton energy U is minimal (all 3D positions are optimized at the same time).

The length and angle of the connection between two anchor points is directly determinable from the 3D positions of the plurality of anchor points. For example, spherical coordinates may be used having an origin at the 3D position of one anchor point such that the spherical coordinates indicate the 3D position of the other anchor point relative to the one in which the local coordinate system is centered.

Moreover, in some embodiments, the data points between two anchor points are used in addition. In such embodiments, a new anchor point is generated between two other anchor points, wherein the 3D position of the new anchor point is based on the 3D positions of the two other anchor points. The new anchor point then lies on the connection between the other two anchor points and belongs to the class that is associated with the connection between the two other anchor points.

For example, the 3D position of the new anchor point may be the average position of the 3D positions of the other two anchor points. For illustration, the new anchor point may account for the upper left arm with the 3D position:

$$\vec{{q}_{new}} = \frac{1}{2} \cdot ( \vec{{q}_{3}} + \vec{{q}_{4}} ) .$$

Then, this adds another contribution to the skeleton energy U which depends on the 3D positions of both the anchor points A3 and A4 and on the data points belonging to the class which is associated with the connection between the anchor points A3 and A4.

Hence, certain constraints may be enforced in the fit of the 3D skeleton model, for example, symmetric limb lengths, predetermined body ratios and predetermined connection angle ranges.

Returning to FIG. 2, at 14, the fitted 3D skeleton model 20 is output, e.g., to another program running on the IPD 5 to use the information for providing safety features. The fitted 3D skeleton model 20 may further be output to a display device to provide visual feedback to the driver 6.

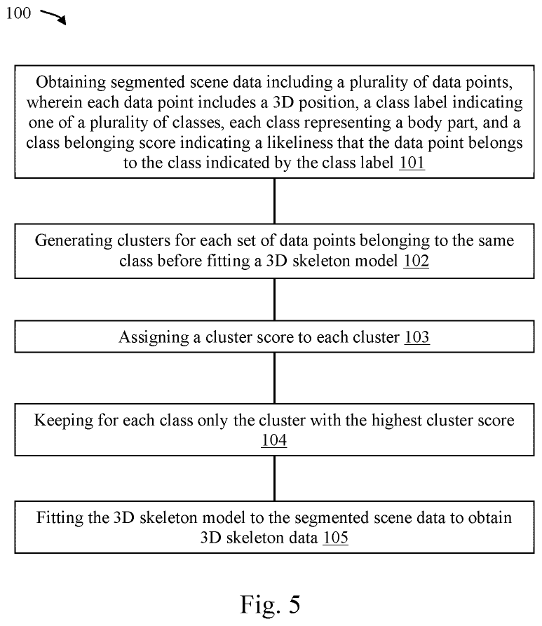

FIG. 5 schematically illustrates in a flow diagram an embodiment of an information processing method 100, which is discussed in the following.

The information processing method 100 may be performed by the information processing device as described herein, e.g., by the IPD 5 of FIG. 1.

At 101, segmented scene data including a plurality of data points is obtained, wherein each data point includes a 3D position, a class label indicating one of a plurality of classes, each class representing a body part, and a class belonging score indicating a likeliness that the data point belongs to the class indicated by the class label, as discussed herein.

At 102, clusters for each set of data points belonging to the same class are generated before fitting a 3D skeleton model, as discussed herein.

At 103, a cluster score is assigned to each cluster, as discussed herein.

At 104, only the cluster with the highest cluster score is kept for each class, as discussed herein.

At 105, the 3D skeleton model is fitted to the segmented scene data to obtain 3D skeleton data, as discussed herein.

Returning to the general explanations, summing up some aspects of some embodiments:

Some embodiments pertain to a processing pipeline to transform depth sensor data into 3D skeleton data representing a fitted 3D skeleton model of a body in a scene.

In some embodiments, the pipeline includes obtaining 3D segmented points, clustering and cleaning and skeleton energy minimization, as discussed herein.

According to some embodiments, at least one of the following may be provided or achieved:

Accurate skeleton anchor points 3D positions.

As the pipeline is in 3D, the limb lengths of the individual do not need to change when the body is moving in the 3D space (in contrast to 2D cases, e.g., where a person size would change depending on its position relative to the camera).

The pipeline may provide good results, even when the individual (whose skeleton is computed) is interacting with the environment. This may be mainly achieved by the segmentation maps, which may disregard the environment pixels.

The pipeline may better deal with occlusion and missing depth pixels due to the knowledge of limb lengths and body structure (symmetry, limb length ratios . . . ).

The pipeline may output valid values for different skeleton sizes (children and adults for example).

The computation of the clustering and anchor points regression with energy minimization may be comparable fast.

It may be possible to improve the output and perform algorithm adjustments without running a full new neural network training which may be important in a context where clients requests should be answered quickly, for example.

The alternative (running a full neural network pipeline outputting directly the skeleton 2D/3D positions) would require new tagged data and trainings, which may take a lot of time and may cost a lot of money.

The segmentation maps typically used for this approach may be used by other modules (for instance understanding which part of the image are pixels of a seat).

A skeleton in 3D space may be more complex than some 2D skeletons.

Going from 3D segmented points to a valid skeleton may be done by taking the average of each cloud of points (for each class), but this may not provide accurate results in some cases.

In such cases, adding human skeleton constraints (fixed limb lengths, limb length ratios, symmetry . . . ) may be a difficult task. Moreover, iterative processes in 3D geometry may be hard to deal with (gimbal locks, local minima . . . ).

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An information processing device for transforming depth sensor data into 3D skeleton data representing a fitted 3D skeleton model of a body in a scene, including circuitry configured to:
   obtain segmented scene data including a plurality of data points, wherein each data point includes a 3D position, a class label indicating one of a plurality of classes, each class representing a body part, and a class belonging score indicating a likeliness that the data point belongs to the class indicated by the class label; and
   fit the 3D skeleton model to the segmented scene data to obtain the 3D skeleton data.
(2) The information processing device of (1), wherein the 3D skeleton model has a graph structure including a plurality of interconnected anchor points including a plurality of joints, wherein each anchor point belongs to one of the plurality of classes.
(3) The information processing device of (2), wherein the 3D skeleton model is fitted by updating the 3D positions of the plurality of anchor points such that a skeleton energy is minimized.
(4) The information processing device of (3), wherein the 3D skeleton model is fitted under at least one of the following constraints: symmetric limb lengths, predetermined body ratios and predetermined connection angle ranges.
(5) The information processing device of (3) or (4), wherein the skeleton energy is based on a plurality of spring energy formulas, wherein in each spring energy formula stiffness is the class belonging score and displacement is the distance between the 3D position of the anchor point and the 3D positions of the corresponding data points.
(6) The information processing device of anyone of (1) to (5), wherein the circuitry is configured to generate clusters for each set of data points belonging to the same class before fitting the 3D skeleton model.
(7) The information processing device of (6), wherein the circuitry is configured to assign a cluster score to each cluster.
(8) The information processing device of (7), wherein the circuitry is configured to keep for each class only the cluster with the highest cluster score.
(9) The information processing device of (7) or (8), wherein the cluster score is the sum of the class belonging scores of the data points included in the respective cluster.
(10) The information processing device of anyone of (1) to (9), wherein the circuitry is configured to obtain the segmented scene data by:
   obtaining and inputting the depth sensor data into a segmentation neural network to obtain the class label and the class belonging score for each data point; and
   determining the 3D position of each data point based on the depth sensor data.
(11) An information processing method for transforming depth sensor data into 3D skeleton data representing a fitted 3D skeleton model of a body in a scene, including:
   obtaining segmented scene data including a plurality of data points, wherein each data point includes a 3D position, a class label indicating one of a plurality of classes, each class representing a body part, and a class belonging score indicating a likeliness that the data point belongs to the class indicated by the class label; and
   fitting the 3D skeleton model to the segmented scene data to obtain the 3D skeleton data.
(12) The information processing method of (11), wherein the 3D skeleton model has a graph structure including a plurality of interconnected anchor points including a plurality of joints, wherein each anchor point belongs to one of the plurality of classes.
(13) The information processing device of (12), wherein the 3D skeleton model is fitted by updating the 3D positions of the plurality of anchor points such that a skeleton energy is minimized.
(14) The information processing method of (13), wherein the 3D skeleton model is fitted under at least one of the following constraints: symmetric limb lengths, predetermined body ratios and predetermined connection angle ranges.
(15) The information processing method of (13) or (14), wherein the skeleton energy is based on a plurality of spring energy formulas, wherein in each spring energy formula stiffness is the class belonging score and displacement is the distance between the 3D position of the anchor point and the 3D positions of the corresponding data points.
(16) The information processing method of anyone of (11) to (15), including generating clusters for each set of data points belonging to the same class before fitting the 3D skeleton model.
(17) The information processing method of (16), including assigning a cluster score to each cluster.
(18) The information processing method of (17), including keeping for each class only the cluster with the highest cluster score.
(19) The information processing method of (17) or (18), wherein the cluster score is the sum of the class belonging scores of the data points included in the respective cluster.
(20) The information processing method of anyone of (11) to (19), including obtaining the segmented scene data by:
   obtaining and inputting the depth sensor data into a segmentation neural network to obtain the class label and the class belonging score for each data point; and
   determining the 3D position of each data point based on the depth sensor data.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. An information processing device for transforming depth sensor data into 3D skeleton data representing a fitted 3D skeleton model of a body in a scene, comprising circuitry configured to:
obtain segmented scene data including a plurality of data points, wherein each data point includes a 3D position, a class label indicating one of a plurality of classes, each class representing a body part, and a class belonging score indicating a likeliness that the data point belongs to the class indicated by the class label; and
fit the 3D skeleton model to the segmented scene data to obtain the 3D skeleton data.

2. The information processing device according to claim 1, wherein the 3D skeleton model has a graph structure including a plurality of interconnected anchor points including a plurality of joints, wherein each anchor point belongs to one of the plurality of classes.

3. The information processing device according to claim 2, wherein the 3D skeleton model is fitted by updating the 3D positions of the plurality of anchor points such that a skeleton energy is minimized.

4. The information processing device according to claim 3, wherein the 3D skeleton model is fitted under at least one of the following constraints: symmetric limb lengths, predetermined body ratios and predetermined connection angle ranges.

5. The information processing device according to claim 3, wherein the skeleton energy is based on a plurality of spring energy formulas, wherein in each spring energy formula stiffness is the class belonging score and displacement is the distance between the 3D position of the anchor point and the 3D positions of the corresponding data points.

6. The information processing device according to claim 1, wherein the circuitry is configured to generate clusters for each set of data points belonging to the same class before fitting the 3D skeleton model.

7. The information processing device according to claim 6, wherein the circuitry is configured to assign a cluster score to each cluster.

8. The information processing device according to claim 7, wherein the circuitry is configured to keep for each class only the cluster with the highest cluster score.

9. The information processing device according to claim 7, wherein the cluster score is the sum of the class belonging scores of the data points included in the respective cluster.

10. The information processing device according to claim 1, wherein the circuitry is configured to obtain the segmented scene data by:
obtaining and inputting the depth sensor data into a segmentation neural network to obtain the class label and the class belonging score for each data point; and
determining the 3D position of each data point based on the depth sensor data.

11. An information processing method for transforming depth sensor data into 3D skeleton data representing a fitted 3D skeleton model of a body in a scene, comprising:
obtaining segmented scene data including a plurality of data points, wherein each data point includes a 3D position, a class label indicating one of a plurality of classes, each class representing a body part, and a class belonging score indicating a likeliness that the data point belongs to the class indicated by the class label; and
fitting the 3D skeleton model to the segmented scene data to obtain the 3D skeleton data.

12. The information processing method according to claim 11, wherein the 3D skeleton model has a graph structure including a plurality of interconnected anchor points including a plurality of joints, wherein each anchor point belongs to one of the plurality of classes.

13. The information processing device according to claim 12, wherein the 3D skeleton model is fitted by updating the 3D positions of the plurality of anchor points such that a skeleton energy is minimized.

14. The information processing method according to claim 13, wherein the 3D skeleton model is fitted under at least one of the following constraints: symmetric limb lengths, predetermined body ratios and predetermined connection angle ranges.

15. The information processing method according to claim 13, wherein the skeleton energy is based on a plurality of spring energy formulas, wherein in each spring energy formula stiffness is the class belonging score and displacement is the distance between the 3D position of the anchor point and the 3D positions of the corresponding data points.

16. The information processing method according to claim 11, comprising generating clusters for each set of data points belonging to the same class before fitting the 3D skeleton model.

17. The information processing method according to claim 16, comprising assigning a cluster score to each cluster.

18. The information processing method according to claim 17, comprising keeping for each class only the cluster with the highest cluster score.

19. The information processing method according to claim 17, wherein the cluster score is the sum of the class belonging scores of the data points included in the respective cluster.

20. The information processing method according to claim 11, comprising obtaining the segmented scene data by:
obtaining and inputting the depth sensor data into a segmentation neural network to obtain the class label and the class belonging score for each data point; and
determining the 3D position of each data point based on the depth sensor data.
